(19) United States
(12) Patent Application Publication
(10) Pub. No.: US 2014/0102486 A1
(43) Pub. Date: Apr. 17, 2014

(54) CLEANING AGENT FOR REMOVAL OF CONTAMINATES FROM MANUFACTURED PRODUCTS

(71) Applicants: Kyle J. Doyel, Franklin, TN (US); Michael L. Bixenman, Old Hickory, TN (US); David T. Lober, Franklin, TN (US); Wayne Raney, White House, TN (US); Kevin Soucy, Nashville, TN (US); Ram Wissel, Franklin, TN (US)

(72) Inventors: Kyle J. Doyel, Franklin, TN (US); Michael L. Bixenman, Old Hickory, TN (US); David T. Lober, Franklin, TN (US); Wayne Raney, White House, TN (US); Kevin Soucy, Nashville, TN (US); Ram Wissel, Franklin, TN (US)

(21) Appl. No.: 13/779,924

(22) Filed: Feb. 28, 2013

Related U.S. Application Data
(60) Provisional application No. 61/714,327, filed on Oct. 16, 2012.

(51) Int. Cl. C11D 7/50

(52) U.S. Cl. CPC C11D 7/5022
USPC 134/29; 510/506; 510/500; 510/499; 510/402; 510/401; 510/488; 510/479; 510/109; 134/42

(57) ABSTRACT

A composition effective for removing contaminates from a manufactured product either as a concentrated material or when diluted with water. The composition designed for effective removal of all types of undesirable contaminates from a manufactured product, including but not limited to, solder flux, oils, greases, soil, and particulate matter. Depending on the nature of the process the cleaning composition maybe used in a multistep process. The composition contains propylene glycol phenyl ether and an alkali and has a pH of greater than 7.5. The composition may contain additional optional solvents and additives to enhance cleaning of articles or to impart other properties to the composition. The composition can be contacted with a surface to be cleaned in a number of ways and under a number of conditions depending on the manufacturing or processing variables present.

### CROSS-REFERENCE TO RELATED APPLICATION

This application claims the benefit of Provisional Application Ser. No. 61/714,327, filed Oct. 16, 2012, entitled Cleaning Agent for Removal of Contaminates from Manufactured Products, which is embodied herein in its entirety.

### FIELD OF THE INVENTION

This invention related to a composition and method for removing soils, fluxes, or other contaminates from manufactured products.

### BACKGROUND

In the manufacturing processes for many products, there are oils, greases, soils, fluxes, and other contaminates that are either deliberately added for ease of manufacture, or are introduced undesirably to the part. Many manufactured products will require these contaminates to be removed before certain steps or after completion of the product. Failure to completely remove these contaminates from products can lead to a wide range of failures, from being aesthetically unpleasing, to a catastrophic product failure that may result in the loss of life.

### BRIEF SUMMARY OF THE INVENTION

According to the present invention, a composition is provided which is effective for removing solder flux, soils, oils, greases, and other undesirable contaminates either as a concentrated material or diluted with water, preferably, although not limited to a dual solvent process. The composition is effective to remove, in conjunction with a rinsing and/or drying step, all types of undesirable contaminates from a manufactured product, including but not limited to, solder flux, oils, greases, soil, and particulate matter. The composition exhibits excellent cleaning and rinsing properties with polar and nonpolar rinse agents such as alcohols, and halogenated carbon compounds. The composition comprises propylene glycol phenyl ether (PGPE) and an alkali. Optionally the concentrated composition may have a secondary solvent system that is added with the PGPE to make the total amount of solvent in the concentrated composition range from 0.01 to 99.99 weight percent, and preferably from 30 to 99.99% weight percent. Conversely the alkali may range from 0.01% to 70 weight percent. Optionally up to 10 percent, preferably up to 3 percent, of a non-ionic surfactant may be added to the concentrated composition to assist in cleaning efficacy. Optionally corrosion inhibitors, buffering agents, chelating agents and/or sequestrants may be added as would be known by one skilled in the art. The concentrated composition may be used neat (at 100%) or diluted with water to result in a concentration of the composition from 99.1 weight percent to 0.1 weight percent of the concentrated composition. The use of the dilute or the concentrated cleaning agent will allow for the use of the cleaning agent in multiple styles of cleaning machines and cleaning processes. When diluted the concentration of the composition is an amount effective to dissolve, remove and clean solder flux, soils, oils, greases, and other undesirable contaminates from the manufactured product. It is to be noted that all concentrations in the specification and claims of this application are in weight percent unless noted otherwise.

The present invention also contemplates a method of removing solder flux, soils, oils, greases, and other undesirable contaminates by contacting a substrate containing the solder flux in a dual solvent process with the composition of the invention. In this context, “substrate” is defined as any part or manufactured product that is contaminated with solder flux, soils, oils, greases, and other undesirable contaminates.

### DETAILED DESCRIPTION OF THE INVENTION

In accordance with the invention, novel cleaning compositions have been formulated comprising PGPE and one or more alkaline agents that render the pH of the concentrated cleaning composition greater than about 7.5. Optionally, the composition contains one or more additional solvents, non-ionic surface active agents, corrosion inhibitors, chelation or sequestering agents, or pH buffering agents, as known by those skilled in the art. Also, agents that modify the foaming characteristics may be used. Agents that modify foaming characteristics are additives which reduce the surface tension of a solution or emulsion, thus inhibiting or modifying the formation of a foam. Commonly used agents are insoluble oils, dimethyl polysiloxanes and other silicones, certain alcohols, stearates and glycols. The additive is used to prevent formation of foam or is added to break a foam already formed. In addition, the composition may contain agents that will aid in increasing the solubility of the cleaning agent in a rinsing agent or agents that will assist in removing the cleaning agent from a rinsing agent to recover the cleaning agent and/or rinsing agent, both as described more fully in co-pending application Ser. No. 13/773,735, filed Feb. 22, 2013, and entitled “Method and Apparatus for Continuous Separation of Cleaning Solvent from Rinse Fluid in a Dual-Solvent Vapor Degreasing System,” with which the instant application is commonly assigned, and which is embodied herein by reference in its entirety (hereinafter referred to as the “Dual-Solvent Vapor Degreasing System.” Each of these additives may comprise one agent or a mixture of agents in order to impart the desired characteristic to the final cleaning composition. The concentrated composition may be used neat (at 100%) or diluted with water to result in a concentration of the composition from 99.9 weight percent to 0.1 weight percent of the concentrate composition.

The use of the dilute or the concentrated cleaning agent will allow for the use of the cleaning agent in multiple styles of cleaning machines and cleaning processes such as those taught in the Dual-Solvent Vapor Degreasing System. When diluted the concentration of the composition is an amount effective to dissolve, remove and clean solder flux, soils, oils, greases, and other undesirable contaminates from the manufactured product.

It is another important aspect of the present invention that the cleaning agent can optionally be removed from a rinsing agent which may be desired by the user to decrease the consumption of cleaning agent and/or rinsing agent, or decrease the environmental impact of the cleaning process. This is preferably accomplished by utilizing the apparatus and method of the Dual-Solvent Vapor Degreasing System.

As discussed above, the invention contemplates a concentrated liquid cleaning composition which comprises PGPE and a sufficient amount of an alkali to result in a pH at least about 7.5. The composition may be diluted with water to a concentration of 0.1 to 99.9 wt %. In a preferred embodiment, the composition is not diluted, meaning that the cleaning agent has a concentration of 100%.

In another embodiment, the composition may contain at least one additional secondary solvent that imparts different solubility parameters for different soils, solder fluxes, or other contaminates.

The secondary solvent or solvents may be in the composition in a total amount of up to 90%, preferably up to 70%. The secondary solvent or solvents can be one or more of the following:
(a) a glycol ether of the formula R₁—O—(CₓH₂ₓO)ₙ—H, wherein:
   R₁ is an alkyl group having 1 to 6 carbon atoms,
   n is an integer from 1 to 4, and
   x is an integer from 1 to 4
(b) an alcohol of the formula R₂—OH, wherein:
   R₂ is an alkyl group having 1 to 8 carbon atoms, a tetrahydrofurfuryl group, or hydrogen
(c) an N-alkyl pyrollidone of the formula R₃Npyrr, wherein:
   Npyrr represents a pyrollidone ring
   R₃ is an alkyl group having 1 to 8 carbon atoms
(d) a dibasic ester of the formula R₄—O—OC—(CH₂)ₖ—CO—O—R₄, wherein:
   R₄ is methyl, ethyl, or isobutyl
   k is an integer from 2 to 4
(e) a halogenated organic solvent containing one or more halogen atoms.

The glycol ether is one or more selected from the group consisting of dipropylene glycol methyl ether, dipropylene glycol propyl ether, dipropylene glycol butyl ether, tripropylene glycol methyl ether, diethylene glycol butyl ether, methoxy methyl butanol, tetrahydrofurfuryl alcohol, N-methyl pyrollidone, N-ethyl pyrollidone, N-propyl pyrollidone, N-octyl pyrollidone, dimethyl adipate, dimethyl succinate, dimethyl glutarate, diisobutyl adipate, diisobutyl succinate and diisobutyl glutarate.

The alkali is one or more of an amine, imide, inorganic hydroxide, silicate, or phosphate and is present in an amount of 0.01 to 70 wt %.

The preferred amine is an alkanolamine.

The alkanolamine is selected from the group consisting of monoethanolamines, diethanolamines, triethanolamines, aminomethylpropanol, methylethanolamine, methyldiethanolamine, dimethylethanolamine, diglycolamine, methylethanolamine, monomethylethylethanolamine, dimethylaminopropylamine, aminopropyldiethanolamine, isopropylhydroxylamine, dimethylamino methyl propanol and combinations thereof

The inorganic salts are selected from the group consisting of sodium hydroxide, potassium hydroxide, sodium silicate, sodium metasilicate, potassium silicate, sodium phosphate, potassium phosphate and combinations thereof

One or more surface active agents preferably are added to improve cleaning, or processing. It is preferred that the surface active agent is a nonionic surfactant. The nonionic surfactant is added in an amount less than 10% and preferably less than 3% of the weight of the composition.

One or more corrosion inhibitors may be added to the composition to improve compatibility with either the equipment used to apply or remove the cleaning agent or with the manufactured product that is undergoing the cleaning process. Preferred corrosion inhibitors are selected from the group consisting of benzotriazoles, derivatives of benzotriazoles, water soluble silicates, and inorganic salts of phosphoric acid. The preferred corrosion inhibitor is an alkali salt of a metasilicate.

One or more buffering agents may be added to provide pH control. Preferred buffering agents are selected from the group consisting of mono, di and tri-carboxylic acids. The preferred buffering agent is one or more of 2-hydroxypropane-1,2,3-tricarboxylic acid, C₃ to C₂₀ mono carboxylic acids, hydrogen alkali salts of phosphoric acid, and boric acid. The buffering agent is added an a concentration effective to keep the pH at least 7.5 and, preferably, above 7.5.

At least one chelating or sequestering agent may be added to the composition. Preferred chelation or sequestering agents are ethylenediaminetetraacetic acid (EDTA) or its salts and ethylenediamine-N,N′-disuccinic acid or its salts.

In another aspect of the invention, a method is provided which comprises a dual-solvent process utilizing the invention as the cleaning agent in the Dual-Solvent Vapor Degreasing System. The current invention is well suited to be the cleaning agent in the dual solvent-process. Following the wash stage the part is conveyed into a vapor-degreasing unit to be rinsed with continuously refluxing rinsing agents. The choice of the rinsing agent may be ascertained by those skilled in the art. Those skilled in the art should also be able to develop a method for removing the current invention from the rinsing agent recovering the cleaning agent and/or rinsing agent for re-use in the cleaning process.

In yet another aspect of the invention a method is provided which comprises a single stage wash with the composition in a manner known to those skilled in the art of cleaning. The wash is followed by a rinse stage to remove the composition from the part followed by a dry stage. Wash and rinse can be accomplished by means of spraying, spray under immersion, agitation, ultrasonics, dipping, tumbling, wiping or immersion. The wash may be conducted at ambient temperature or as low as 2 degrees C. below the flash point of the composition.

Preferred embodiments of the composition and method of the present invention are described in detail in the following examples which should not be construed to limit the scope of the present invention.

### EXAMPLE 1

### Formulation

A concentrated cleaning agent was formulated with a composition of 88.0% PGPE, 2.00% of a triazole inhibitor, 2.5% of a secondary alkanolamine 2.5% of a tertiary alkanolamine, 2.5% of a tertiary amine surfactant, and 2.5% buffering agent consisting of C₃ to C₂₀ mono carboxylic acids and/or their alkali metal salts. The pH of the neat cleaning agent was 11.5.

### EXAMPLE 2

The concentrated cleaning agent described in Example 1 was placed in a dual solvent system that utilizes Spray Under Immersion (SIU), without any dilution (100% concentration). Various electrical and metal parts were deliberately contaminated with soils, and then placed in the SIU machine for washing. Upon completion of the cleaning cycle the parts were placed in a vapor degreasing process for rinsing and drying. Rinsing was achieved by vapor degreasing in refluxing 1,1,1,2,2,3,4,5,5,5-decafluoropentane, which was utilized as a rinsing agent. Drying was achieved by letting the residual rinsing agent evaporate under ambient conditions. The cleanliness of the parts was exceptional.

### EXAMPLE 3

The concentrated cleaning agent described in Example 1 was applied neat (100% concentration) manually to various parts that were deliberately contaminated with various soils, greases, and in a static soak wash. No heat or mechanical actionns were applied. The cleaning agent was removed by manually rinsing with 1,1,1,2,2,3,4,5,5,5-decafluoropentane. The cleanliness of the parts was exceptional.

Various modifications and alterations of this invention will be apparent to those skilled in the art without departing from the scope and spirit of this invention.

What is claimed is:

1. A composition effective for removing a contaminant from a manufactured product consisting essentially of propylene glycol phenyl ether, an alkali, and optionally one or more secondary solvents, and has a pH of at least about 7.5.

2. The composition of claim 1, further containing water.

3. The composition of claim 2, wherein said composition is diluted with said water to a concentration of from about 99.9 weight % to about 0.1 weight %.

4. The composition of claim 1, wherein said secondary solvent is present in an amount up to about 90%.

5. The composition of claim 1, wherein the secondary solvent is a member of the group consisting of
(a) a glycol ether of the formula R₁—O—(CₓH₂ₓO)ₙ—H, wherein:
R₁ is an alkyl group having 1 to 6 carbon atoms,
n is integer from 1 to 4, and
x is integer from 1 to 4;
(b) an alcohol of the formula R₂—OH, wherein:
R₂ is an alkyl group having 1 to 8 carbon atoms, a tetrahydrofurfuryl group, or hydrogen;
(c) an N-alkyl pyrollidone of the formula R₃Npyrr, wherein:
Npyrr represents a pyrollidone ring
R₃ is an alkyl group having 1 to 8 carbon atoms; and
(d) a dibasic ester of the formula R₄—O—CO—(CH₂)ₖ—CO—O—R₄, wherein:
R₄ is Methyl, ethyl, or isobutyl
k is an integer from 2 to 4.
(e) a halogenated organic solvent containing one or more atoms of one or more halogens and mixtures thereof.

6. The composition of claim 4, wherein the secondary solvent is selected from the group consisting of: dipropylene glycol methyl ether, dipropylene glycol propyl ether, dipropylene glycol butyl ether, tripropylene glycol methyl ether, diethylene glycol butyl ether, methoxy methyl butanol, tetrahydrofurfuryl alcohol, water, N-methyl pyrollidone, N-ethyl pyrollidone, N-propyl pyrollidone, N-octyl pyrollidone, dimethyl adipate, dimethyl succinate, dimethyl glutarate, diisobutyl adipate, diisobutyl succinate and diisobutyl glutarate, and mixtures thereof.

7. The composition of claim 1, wherein the alkali is one or more of an amine, an imide or an inorganic alkaline salt, and is present in an amount of 0.01 to 70 weight percent.

8. The composition of claim 7, wherein the inorganic alkaline salt is selected from the group consisting of sodium hydroxide, potassium hydroxide, a silicate or a phosphate and mixtures thereof.

9. The composition of claim 8, wherein the silicate is selected from the group consisting of sodium silicate, sodium metasilicate, and potassium silicate, and the phosphate is selected from the group consisting of sodium phosphate and potassium phosphate.

10. The composition of claim 7, wherein the amine is an alkanolamine.

11. The composition of claim 10, wherein the alkanolamine is selected from the group consisting of monoethanolamines, diethanolamines, triethanolamines, aminomethylpropanol, methylethanolamine, methyldiethanolamine, dimethylethanolamine, diglycolamine, methylethanolamine, monomethylethylethanolamine, dimethylaminopropylamine, aminopropyldiethanolamine, isopropylhydroxylamine, dimethylamino methyl propanol and combinations thereof

12. A composition of claim 1, wherein said propylene glycol phenyl ether is present at a concentration of 0.1% to 99.99% and said alkali is present at a concentration of 0.01% to 90.00% to thereby render the pH greater than 7.5.

13. The composition of claim 1, further comprising a non ionic surface active agent.

14. The composition of claim 13, wherein said non ionic surface active agent is present in an amount of up to about 10%.

15. The composition of claim 14, wherein said non ionic surface active agent is present in an amount of up to about 3%.

16. The composition of claim 1, further comprising a corrosion inhibitor.

17. The composition of claim 16, wherein said corrosion inhibitor is selected from the group consisting of benzotriazoles, derivatives of benzotriazoles, water soluble silicates, inorganic salts of phosphoric acid, and mixtures thereof.

18. The composition of claim 17, wherein said corrosion inhibitor is an alkali salt of a metasilicate.

19. The composition of claim 1, further comprising a buffering agent.

20. The composition of claim 19, wherein said buffering agent is selected from the group consisting of mono, di and tri-carboxylic acids, and mixtures thereof.

21. The composition of claim 20, wherein said buffering agent is one or more of 2-hydroxypropane-1,2,3-tricarboxylic acid, C₃ to C₂₀ mono carboxylic acids, hydrogen alkali salts of phosphoric acid, and boric acid.

22. The composition of claim 19, wherein said buffering agent is present at a concentration effective to keep the pH at least 7.5.

23. The composition of claim 22, wherein said buffering agent is present at a concentration effective to keep the pH above 7.5.

24. The composition of claim 1, further including at least one chelating agent.

25. The composition of claim 24, wherein said chelating agent is selected from the group consisting of ethylenediaminetetraacetic acid or its salts and ethylenediamine-N,N′-disuccinic acid or its salts, and mixtures thereof.

26. The composition of claim 1, further including a foaming modifying agent.

27. The composition of claim 1, whereins aid contaminant is solder flux.

28. A method of removing a contaminant from a substrate comprising contacting said substrate with the composition of claim 1 at a temperature and a contact time sufficient to remove said solder flux.

29. A method according to claim 28, wherein said washing stage is followed by a rinsing stage and a drying stage.
